(19) United States
(12) Patent Application Publication
(10) Pub. No.: US 2004/0176079 A1
(43) Pub. Date: Sep. 9, 2004

(54) User controllable hold audio in a mobile communication device

(76) Inventor: Roger A. Fratti, Mohnton, PA (US)

Correspondence Address: Ryan, Mason & Lewis, LLP, 90 Forest Avenue, Locust Valley, NY, 11560, US

(21) Appl. No.: 10/371,496

(22) Filed: Feb. 20, 2003

(51) Int. Cl. H04M 3/42

(52) U.S. Cl. 455/414.1; 455/550.1

(57) ABSTRACT

A mobile communication device comprises memory and at least one processor coupled to the memory. The at least one processor is operative: (i) to control establishment of a call with another communication device via a wireless communication channel; and (ii) to place the call in a hold state subsequent to establishment of the call. A call hold functionality for placing the call in the hold state is implemented substantially entirely within the mobile communication device, without requiring additional hold circuitry external to the device. The at least one processor may be further operative to control playing of an audio signal during at least a portion of a time the call is placed in the hold state.

### FIELD OF THE INVENTION

The present invention relates generally to wireless communication systems, and more particularly relates to mobile communication devices.

### BACKGROUND OF THE INVENTION

There are many circuit arrangements known in the art of telephony for providing a call holding condition on a traditional wireline telephone network, such as a public switched telephone network (PSTN), or a related switch, such as a private branch exchange (PBX). Methodologies for providing a music-on-hold feature are also known. The music-on-hold feature generally involves injecting an audio signal, typically music, into the line when it is placed on hold in an attempt to alleviate the boredom associated with waiting for a held call to recommence. For example, U.S. Pat. No. 4,492,822 to Alderman is directed to a hold circuit for use in a traditional telephone system having a line powered music-on-hold arrangement.

With the recent popularity of wireless communications, many mobile telephone devices attempt to integrate additional features into the device, such as, for example, a personal data assistant (PDA) functionality, the ability to download and play games on the device, customized ring tones, etc. Some wireless telephone handsets, including, for example, iDEN® (Integrated Digital Enhanced Network) series telephones manufactured by Motorola, Inc., are capable of combining the capabilities of a digital cellular telephone, two-way radio, alphanumeric pager, and data/facsimile (fax) modem in a single device. Motorola's iDEN solution is designed to give the mobile user quick access to information without having to carry around several devices.

Not all features available in a traditional PSTN or PBX system have been integrated in a mobile communication environment (e.g., a cellular telephone network). For example, individual mobile communication devices do not implement a call hold capability therein, without requiring an external hold processor and/or alternate external hold circuitry. For example, U.S. Pat. No. 6,138,030 to Coombes et al. is directed to a communications system providing a hold feature for one or more mobile subscribers actively engaged in a communication service provided by a central office associated with the communications system. A hold processor (e.g., a hold server) comprised in the central office provides such hold capability for the communications system. However, since the call hold functionality originates in the central office rather than in the mobile device itself, to obtain the hold feature, mobile subscribers must be communicating with a service through that central office, thus significantly limiting the mobility of the mobile subscriber. Moreover, although the Coombes patent discloses that during the time the call is held at the hold server, the portion of the signal that would normally carry voice data can be filled with music, such music is not selectable by the mobile subscriber, but instead originates from the central office. Thus, the hold music cannot be readily or efficiently customized by the individual mobile subscriber.

There exists a need, therefore, in the field of wireless communications, for a mobile communication device which provides a call hold capability implemented in the device itself, and furthermore provides user controllable audio to be played during a held call.

### SUMMARY OF THE INVENTION

The present invention provides techniques, for use in a mobile communication environment, for advantageously providing a call hold feature for a mobile communication device, the call hold feature being implemented in the device itself. Moreover, in one aspect of the invention, the mobile communication device provides user controllable audio to be played during at least a portion of the time the call is placed on hold. This feature enables an individual mobile subscriber to customize the audio to be played during the held call. Such audio may be stored in the mobile communication device itself and/or downloaded from an external source, such as, but not limited to, the Internet.

In accordance with one aspect of the invention, a mobile communication device comprises memory and at least one processor coupled to the memory. The at least one processor is operative: (i) to control establishment of a call with another communication device via a wireless communication channel; and (ii) to place the call in a hold state subsequent to establishment of the call. A call hold functionality for placing the call in the hold state is implemented substantially entirely within the mobile communication device, without requiring additional hold circuitry external to the device.

In accordance with another aspect of the invention, the mobile communication device is further operative to control playing of an audio signal during at least a portion of a time the call is placed on hold. The audio to be played may comprise audio data which is downloadable from an external data network and selectable by a user of the mobile communication device.

These and other features and advantages ofthe present invention will become apparent from the following detailed description of illustrative embodiments thereof, which is to be read in connection with the accompanying drawings.

### BRIEF DESCRIPTION OF THE DRAWINGS

FIG. 1 is a block diagram depicting an illustrative wireless communication system in which the techniques of the present invention may be implemented, in accordance with the invention.

FIG. 2 is a block diagram illustrating an exemplary mobile communication device, formed in accordance with the invention.

FIG. 3 is a block diagram depicting at least a portion of an exemplary hold circuit which may be used in the mobile communication device shown in FIG. 2, in accordance with the invention.

FIG. 4 is a block diagram illustrating an exemplary method for providing a call hold feature in a mobile communication device, in accordance with the invention.

### DETAILED DESCRIPTION OF THE PREFERRED EMBODIMENTS

The present invention will be described herein in the context of a mobile communication system (e.g., cellular/PCS telephone system). It should be appreciated, however, that the present invention is not limited to this or any particular mobile communication system. Rather, the invention is more generally applicable to techniques for advantageously providing a call hold capability to a mobile communication device in a wireless communication system and, furthermore, providing user controllable audio during at least a portion of the time the call is placed on hold. The call hold feature is implemented substantially entirely in the mobile communication device itself, without the need for an external hold processor or alternative external hold circuitry.

The term “audio” as used herein is intended to refer to one or more signals comprising components in a frequency range audible to humans (e.g., about 20 hertz (Hz) to about 20 kilohertz (KHz)). Such audio may originate in an analog format and/or a digital format. For example, the audio may comprise analog voice signals, or the audio may comprise data which can be stored in digital format and subsequently converted (e.g., by a digital-to-analog converter) to an analog audio signal for playback when desired. Furthermore, the digital data may be encoded in accordance with a digital encoding format, such as, but not limited to, Motion Picture Experts Group (MPEG)-1 audio layer three (MP3) data, streaming audio data, etc., as will be understood by those skilled in the art. The MP3 standard is set forth in the International Organization for Standardization (ISO)/International Electro-technical Commission (IEC) document ISO/IEC-11172-3 entitled “Information Technology—Coding of Moving Pictures and Associated Audio for Digital Storage Media up to About 1.5 Mbit/s—Part 3: Audio” (1993), which is incorporated herein by reference. Additional extensions relating to the MP3 standard are also incorporated herein by reference. Also, although particularly well-suited for use in conjunction with the MP3 standard, the invention can be used with other standards, as well as in non-standard systems.

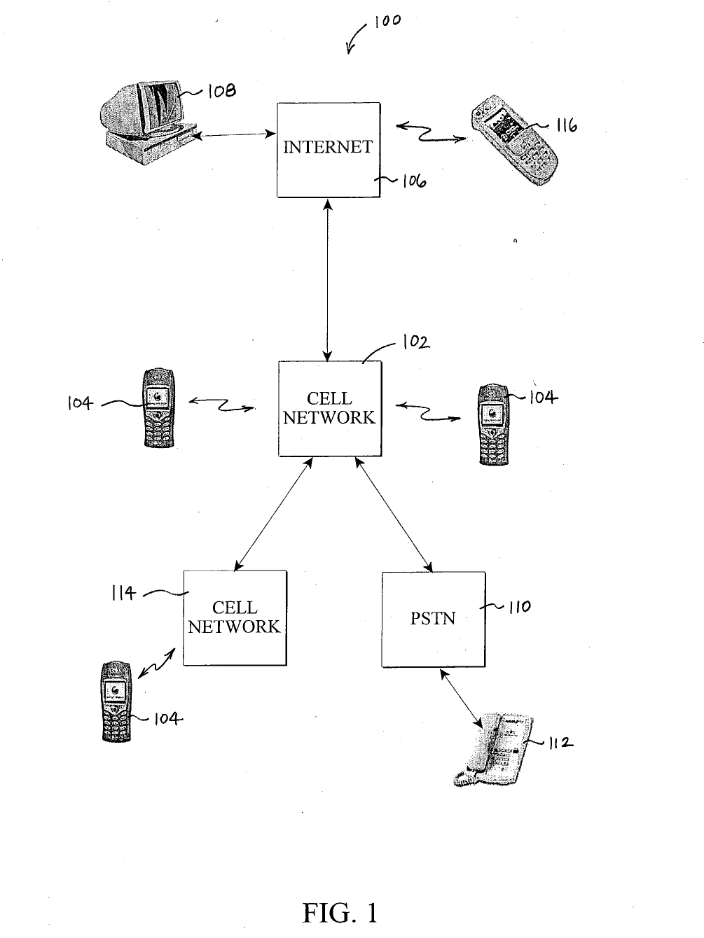

FIG. 1 depicts an illustrative mobile communication system 100 in which the techniques of the present invention may be implemented. The illustrative system 100 may include a cellular telephone network 102 configurable for communicating with one or more mobile communication devices 104. The present invention contemplates that any communication protocol may be employed by the mobile communication system, including, but not limited to, time division multiple access (TDMA), code division multiple access (CDMA), Global System for Mobile Communication (GSM), general packet radio service (GPRS), etc. The cellular network 102 may be operatively coupled to other networks, such as, for example, a data network 106, which may be the Internet, a public switched telephone network (PSTN) 110, and/or other cellular networks 114, to facilitate communication between a plurality of communication devices. Each of these other networks 106, 110, 114 is preferably configurable for communicating with one or more corresponding devices 116, 112, 104, respectively, coupled thereto.

One or more general purpose computers (e.g., a personal computer (PC)) 108 may be operatively coupled to the data network 106. The PC 108 may include a microphone and speaker connected thereto and, running an appropriate communication software program (e.g., PhoneBridge, manufactured by MHL Communications, Inc., Net2Phone®, a registered trademark of Net2Phone, Inc.), may be configurable as an Internet protocol (IP)-based telephony device for communicating over the data network 106 employing, for example, Voice-over IP (VoIP) protocol, Session Initiation Protocol (SIP), or an alternative communication protocol, as will be understood by those skilled in the art. A wireless IP phone 116 may also be used for communicating over the data network 106.

In a conventional manner, a call may be established between two mobile communication devices 104 via one or more cellular networks 102, 114. Likewise, a call may be established between a mobile communication device 104 and a wireline telephone 112 via cellular network 102 and PSTN 110, between a mobile communication device 104 and a PC 108, configured as an IP telephone device, IP telephone 116 via cellular network 102 and data network 106, or between any combination of devices using one or more corresponding networks. Moreover, in a teleconferencing arrangement, for example, a call may be established between more than two devices using any combination of networks and corresponding communication devices.

In a traditional wireline telephone environment, such as, for example, a home or office telephone system, it is known to incorporate a call hold capability into a telephone handset. Furthermore, it is known to provide music and/or other audio to the party while the call is on hold. Such audio may be helpful for alleviating boredom, for providing informational messages, for indicating that the call is still active (i.e., that the call has not been disconnected), etc. In accordance with one aspect of the invention, a mobile communication device is provided which is advantageously configurable for placing a call on hold. The call hold feature is implemented in the mobile communication device itself, rather than requiring external hold circuitry (e.g., an external hold processor) and/or requiring a traditional Centrex-type service. In this manner, the call hold feature is not attached to a particular communication network through which the mobile communication device is communicating.

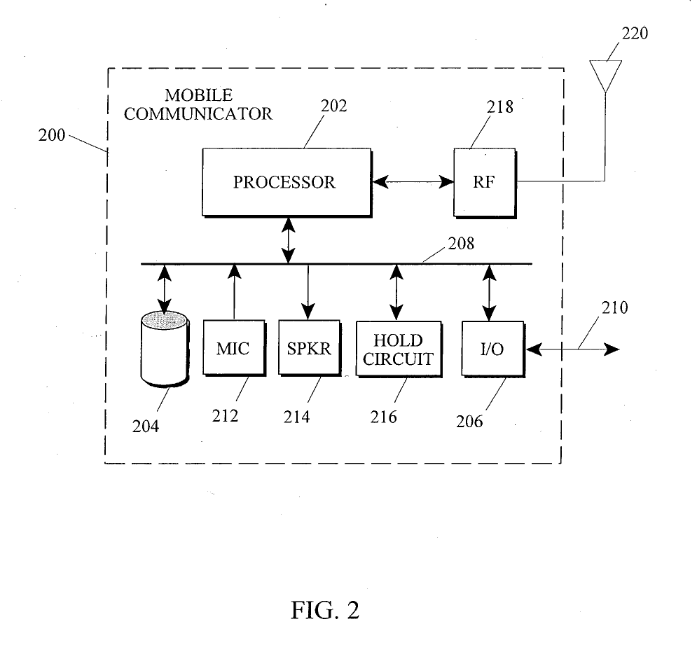

FIG. 2 depicts an exemplary mobile communication device 200, formed in accordance with one aspect of the present invention. The exemplary mobile communication device 200 preferably comprises a processor 202 for implementing at least a portion ofthe methodologies ofthe invention, operatively coupled to a memory 204 and an input/output (I/O) interface 206 via a bus 208. Alternative device elements and connection arrangements may be used.

It is to be appreciated that the term “processor” as used herein is intended to include any processing device, such as, for example, one that includes a central processing unit (CPU) and/or other processing circuitry (e.g., digital signal processor (DSP), digital-to-analog converter, analog-to-digital converter, microprocessor, etc.). Additionally, it is to be understood that the term “processor” may refer to more than one processing device, and that various elements associated with a processing device may be shared by other processing devices.

The term “memory” as used herein is intended to include memory and other computer-readable media associated with a processor, such as, but not limited to, random access memory (RAM), read only memory (ROM), removable storage media (e.g., SmartMedia card), flash memory, etc.

Furthermore, the term “I/O interface” as used herein is intended to comprise circuitry that is configurable for communicating with one or more input devices (e.g., keypad, touchscreen, etc.) for entering data to the processor, and/or one or more output devices (e.g., liquid crystal display (LCD), etc.) for presenting an output associated with the processor. An I/O interface may comprise circuitry for establishing a data connection 210 with an external network (e.g., the Internet) and/or data source, for example, a wired connection and/or a wireless connection (e.g., radio frequency (RF), infrared (IR), etc.).

The exemplary mobile communication device 200 further includes a microphone (MIC) 212, which may be used for inputting audio (e.g., voice) to the communication device, and a speaker (SPKR) 214, which may be used for outputting audio from the device for audible presentation to a user of the device. The microphone 212 and speaker 214 may be coupled to the processor 202 via bus 208. Likewise, the microphone 212 and/or speaker 214 may be coupled to the I/O interface 206. Alternative connection arrangements and circuitry associated therewith are contemplated by the invention.

The exemplary mobile communication device 200 further comprises a radio frequency (RF) block 218 coupled to and at least partially controlled by the processor 202. For example, the processor 202 may be configured for controlling an output power level of the RF block 218. RF blocks suitable for use with the present invention are well known by those skilled in the art, and therefore a detailed description of such RF blocks will not be presented herein. An antenna 220 is preferably coupled to the RF block 218 for receiving and/or transmitting communication signals sent to and/or from, respectively, the mobile communication device 200. The antenna 220 may reside external to the communication device 200, internal to the device, or a combination thereof. The RF block 218 preferably includes circuitry for transmitting (e.g., a power amplifier) and receiving (e.g., receiver, detector, etc.) RF signals from the antenna 220 in a conventional fashion.

The exemplary mobile communication device 200 is preferably configured to establish communication with one or more communication devices in a conventional fashion (e.g., by sending an outgoing call and/or receiving an incoming call). In the device 200, the processor 202 is preferably operative to at least partially control establishment of the call. The exemplary mobile communication device 200 further includes a hold circuit 216, such that once the call has been established, the hold circuit 216 is operative to place the call in a hold state (i.e., “on hold”)in response to a call hold request initiated by a user ofthe mobile communication device. The term “on hold” as used herein is intended to refer to a state wherein the call is inactive but communicating (i.e., not disconnected). For example, while a call is on hold, the microphone 212 and/or speaker 214 may be disabled, so that the user is free to speak without being overheard by the party or parties at the other end(s) of the line. It is to be appreciated that at least a portion of the functionalities of the hold circuit 216 may be implemented by the processor 202.

An active or incoming call may be placed on hold by the user, for example, by pressing one or more buttons, one or more keys, and/or a combination or one or more buttons and keys (not shown), on the user's mobile communication device, e.g., device 200. To retrieve the call after it has been placed on hold, the user may initiate a release request. This may be accomplished, for example, by the user pressing the same button(s), key(s), or combination of buttons and keys as was used to place the call on hold. Alternatively, a distinct button, key, or combination of buttons and keys may be employed to release the call from the hold state and place it in an active state once again.

While the call is on hold, it maybe desirable to present audio (e.g., music, voice, tones, etc.) to the party placed on hold. Thus, in accordance with another aspect of the invention, the hold circuit 216 is further operative to play an audio signal during at least a portion of the time the call is on hold. Thus, at least a portion of the signal conveyed to the party on hold that would normally carry voice signals from the microphone 212, may instead be injected with an audio signal from another audio source (i.e., other than the microphone 212). The audio source may comprise digital audio stored in at least a portion of memory 204 which can be selectively read and converted to an analog audio signal, for example, by a digital-to-analog converter (not shown) associated with the mobile communication device 200, and played to the held party. Alternative and/or multiple audio sources may be similarly employed with the invention.

The audio source maybe at least partially external to the mobile communication device 200. In this case, audio generated by the external audio source may be inputted to the device 200 through a data connection 210 coupled to the V/O interface 206, or via alternative connection means. For example, the mobile communication device may be configurable for establishing a connection with a data network (e.g., the Internet) for selectively downloading audio information to the device 200 for playback to the party on hold. It is to be appreciated that at least a portion of the audio stored in memory 204 may be downloaded before and/or during establishment of the call.

As previously stated, the audio may comprise music, which may be encoded in a digital format (e.g., MP3, streaming audio, etc.), voice (e.g., informational messages), and/or alternative audible signals. Such audio may advantageously serve to relieve boredom while the held party waits for the call to recommence, to provide an indication that the call has not been disconnected, to provide informational messages to the held party, etc.

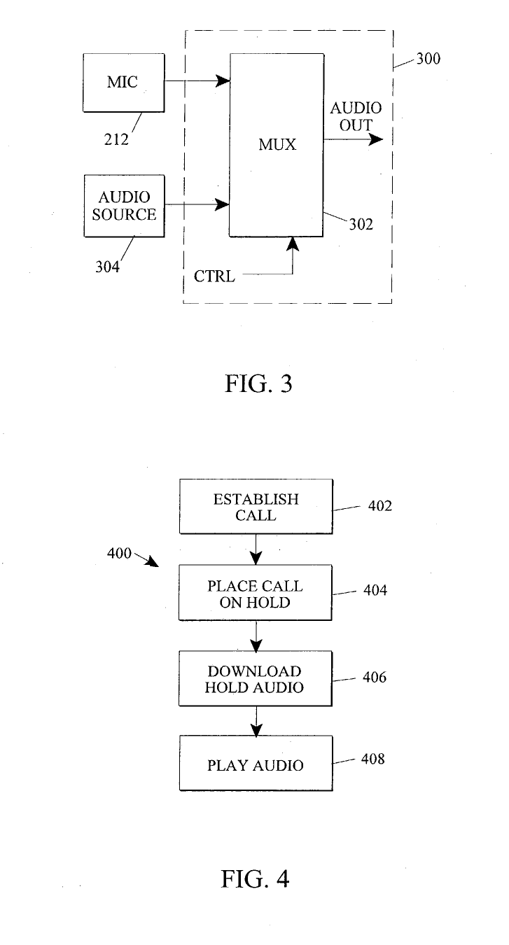

With reference to FIG. 3, there is shown at least a portion of an exemplary hold circuit 300 in which the functionalities of hold circuit 216 shown in FIG. 2 may be implemented. Exemplary hold circuit 300 comprises a multiplexer 302 including two or more audio inputs, each of the audio inputs being coupled to a different audio source, a control input and at least one output (AUDIO OUT). The multiplexer 302 is preferably operative to select one of the audio inputs to be passed to the output in response to a control signal (CTRL) applied to the control input. For example, a first input of the multiplexer 302 may be coupled, either directly or indirectly, to the microphone 212 and a second input ofthe multiplexer may be coupled to a hold audio source 304. The control signal may be generated internal to the hold circuit 300 or, alternatively, the control signal CTRL may be generated external to the hold circuit, such as by the processor 202. For example, the control signal used to disable the microphone and speaker in the mobile communication device in the hold state may also be employed, directly or indirectly, as the control signal for audio input selection.

During a normal call (i.e., a call that is not in a hold state), the multiplexer 302 is configured such that the microphone is selected as the audio input source presented to the output of the multiplexer. Likewise, when the call is placed on hold, the microphone 212 is operatively disabled and, during at least a portion of the time the call is placed on hold, audio source 304 is selected as the audio input source presented to the output of the multiplexer and presented to the party on hold.

With reference again to FIG. 2, in a preferred embodiment of the invention, the mobile communication device 200 is configurable for establishing a connection 210 with a data network, which may include the Internet, and for downloading audio data from the data network over the connection. The downloaded audio data may be stored in the memory 204 for later playback during at least a portion of the time the call is on hold. Likewise, streaming audio data may be downloaded via connection 210 and played to the held party during at least a portion of the time the call is on hold. The establishment of a connection with the data network and the downloading of selected data from the data network may be performed by the mobile communication device, for example, in a manner similar to downloading ring tones, games, MP3 clips, etc., as will be understood by those skilled in the art.

FIG. 4 illustrates an exemplary methodology 400 for providing a call hold feature in a mobile communication device, in accordance with one aspect ofthe invention. In step 402 ofthe exemplary method 400, the mobile communication device establishes a call with one or more communication devices, which may include, for example, a mobile phone, a traditional wireline telephone, an IP phone, etc., as previously described. A call may be established by the mobile communication device user, for example, by entering a called party number and pressing a SEND button associated with the device, as in a conventional fashion. Likewise, the mobile communication device user may establish the call by answering an incoming call from another communication device. The manner in which the call is established is not intended to limit the techniques of the present invention as described herein.

In step 404, the mobile communication device places the call in a hold state, such as, for example, by operatively disabling the microphone and speaker associated with the device. In some instances, it maybe desirable for the speaker in the mobile communication device to remain enabled. In this manner, the mobile device user can listen to the party while the call is on hold. This may be beneficial when the other party has placed the call on hold and the mobile device user would like to monitor the line to determine whether the other party has returned.

Hold audio may be selectively obtained from an external audio source, for example by downloading, in step 406, hold audio from a data network (e.g., the Internet). Such audio can be downloaded in the form of an MP3 file, streaming audio, etc., as previously described. In step 408, the downloaded audio data, or other audio selected by the user, is played during at least a portion of the time the call is on hold. This may be accomplished, for example, by selectively coupling a desired audio source to be transmitted over the communication channel established between the mobile communication device and at least one other communication device as in step 402. It is to be appreciated that the hold audio to be played during at least a portion of a time the call is placed in the hold state may be obtained at any time, such as, for example, prior to establishment of the call, whereby the audio may be stored for later playback (e.g., as an MP3 file), and/or during the call (e.g., as streaming audio).

An application program, or software components thereof, including instructions or code for performing at least a portion of the methodologies of the invention, as described herein, may be stored in one or more memory devices (e.g., ROM, fixed or removable memory) associated with the mobile communication device and/or computer readable media and, when ready to be utilized, loaded in whole or in part (e.g., into RAM) and executed by a processor. In any case, it is to be appreciated that the call hold feature of the invention may be implemented in various forms of hardware, software, or combinations thereof.

It is to be appreciated that while the present invention has been described herein in the context of a mobile communication device, at least a portion of the methodologies of the present invention are capable of being distributed in the form of computer readable media, and that the present invention applies equally regardless of the particular type of signal-bearing media actually used to carry out the distribution. The term “computer readable media” as used herein is intended to include recordable-type media, such as, for example, a floppy disk, a hard disk drive, RAM, compact disk (CD) ROM, etc., and transmission-type media, such as digital and analog communication links, wired or wireless communication links using transmission forms, such as, for example, RF and optical transmissions, etc. The computer readable media may take the form of coded formats that are decoded for use in a particular data processing system.

Although illustrative embodiments ofthe present invention have been described herein with reference to the accompanying drawings, it is to be understood that the invention is not limited to those precise embodiments, and that various other changes and modifications may be made therein by one skilled in the art without departing from the scope of the appended claims. For example, the invention can be used with standards other than MP3, as well as in non-standard applications.

What is claimed is:

1. A mobile communication device, comprising:
memory; and
at least one processor coupled to the memory, the at least one processor being operative: (i) to control establishment of a call with another communication device via a wireless communication channel; and (ii) to place the call in a hold state subsequent to establishment of the call;
wherein a call hold functionality for placing the call in the hold state is implemented substantially entirely within the mobile communication device, without requiring additional hold circuitry external to the device.

2. The device of claim 1, wherein the at least one processor is further operative to control playing of an audio signal during at least a portion of a time the call is placed in the hold state.

3. The device of claim 2, wherein the audio signal to be played during at least a portion of the time the call is placed in the hold state is selectable by at least one of a user of the mobile communication device and a party placed on hold.

4. The device of claim 1, wherein the at least one processor is further operative to retrieve audio from an external audio source and control playing of the retrieved audio during at least a portion of a time the call is placed in the hold state.

5. The device of claim 1, further comprising:
an input/output (I/O) interface operatively coupled to the at least one processor, the I/O interface being configurable for establishing a communication channel between the at least one processor and a data network.

6. The device of claim 5, wherein the at least one processor is further operative to download audio data from the data network and control playing of the audio data during at least a portion of a time the call is placed in the hold state.

7. The device of claim 6, wherein the audio data comprises one or more Motion Picture Experts Group (MPEG) encoded audio files.

8. The device of claim 6, wherein the at least one processor is further operative to receive a user control signal from the I/O interface and to control playing of one or more audio sequences comprised in the audio data during at least a portion of a time the call is placed in the hold state in response to the user control signal.

9. The device of claim 2, wherein the audio comprises a plurality of audio files stored in the memory, and wherein the at least one processor is further operative to select at least one of the plurality of audio files to be played during at least a portion of a time the call is placed in the hold state in response to at least one of a selection by a user of the mobile communication device and a selection by a party placed on hold.

10. The device of claim 1, further comprising a hold circuit operatively coupled to the at least one processor, the hold circuit being operative to place the call in a hold state subsequent to establishment of the call.

11. The device of claim 10, wherein the hold circuit is further operative to play an audio signal during at least a portion of a time the call is placed in the hold state.

12. The device of claim 10, wherein the hold circuit comprises a multiplexer including a first audio input for receiving a voice signal from a user of the mobile communication device, at least a second audio input for receiving audio from an audio source associated with the device, a control input, and an output, wherein the multiplexer is configured to select one of the audio inputs to be coupled to the output in response to a control signal presented to the control input.

13. A method for providing a call hold functionality in a mobile communication device, the method comprising the steps of:
establishing a call between the mobile communication device and another communication device;
placing the call in a hold state subsequent to establishment of the call;
wherein the call hold functionality for placing the call in the hold state is implemented substantially entirely within the mobile communication device, without requiring additional hold circuitry external to the device.

14. The method of claim 13, further comprising the step of playing an audio signal during at least a portion of a time the call is placed in the hold state.

15. The method of claim 14, further comprising the step of selecting, by at least one of a user of the mobile communication device and a party placed on hold, the audio signal to be played during at least a portion of the time the call is placed in the hold state.

16. The method of claim 13, further comprising the steps of:
establishing a communication channel between the mobile communication device and a data network;
downloading audio data from the data network; and
playing the audio data during at least a portion of a time the call is placed in the hold state.

17. The method of claim 16, wherein the step of downloading the audio data is performed prior to establishing the call.

18. The method of claim 16, wherein the step of downloading the audio data is performed after establishing the call.

19. The method of claim 14, further comprising the steps of:
receiving a user control signal; and
playing one or more audio sequences comprised in the audio signal during at least a portion of a time the call is placed in the hold state in response to the user control signal.

20. An article of manufacture for providing a call hold functionality in a mobile communication device, comprising a machine readable medium containing one or more programs which when executed implement the steps of:
establishing a call between the mobile communication device and another communication device;
placing the call in a hold state subsequent to establishment of the call;
wherein the call hold functionality for placing the call in the hold state is implemented substantially entirely within the mobile communication device, without requiring additional hold circuitry external to the device.

21. The article of claim 20, further comprising the step of playing an audio signal during at least a portion of a time the call is placed in the hold state.
